(19) United States
(12) Patent Application Publication
(10) Pub. No.: US 2002/0145509 A1
(43) Pub. Date: Oct. 10, 2002

(54) Power line communications interface to indoor subscriber

(76) Inventors: Igal Karny, Tel Aviv (IL); Avi Lugassi, Netania (IL)

Correspondence Address: WELSH & FLAXMAN LLC, 2341 JEFFERSON DAVIS HIGHWAY, SUITE 112, ARLINGTON, VA, 22202, US

(21) Appl. No.: 10/095,227

(22) Filed: Mar. 12, 2002

Related U.S. Application Data
(60) Provisional application No. 60/275,482, filed on Mar. 14, 2001.

(51) Int. Cl. H04M 11/04

(52) U.S. Cl. 340/310.06; 340/310.01

(57) ABSTRACT

An interface device for partitioning and deliverables from a power line to a home communications network. The deliverables include both electric power and communications signals. The communications signals, such as data signals, are delivered through a LAN to end-points. The device of the invention is bidirectional as it provides both upstream and downstream communications traffic. The interface can also furnish Information to the power meter and obtain information from it.

### FIELD OF THE INVENTION

The present invention relates generally to interfacing home and small office network to PLC (power line communications) services, more particularly the present invention relates to gateways connecting between outdoors power line communications and indoor LANs (local area networks).

### BACKGROUND OF THE INVENTION

Power meters, also known in some cases as watt-hour meters, are employed by electric supply companies to monitor and control the consumption of electric power by their consumers. Such meters are installed in a locality which is conveniently reached by an inspector. Nevertheless, the electrical connection of the meter must be connected at a node on the power line that is external to any of the appliances at the indoor or consumer premises. The meters are adapted for service in the outdoors environment, such that their performance is not impaired by hostile weather phenomena. The point on the power lines at which the power meters are employed coincides usually with the border point between two ownership domains. The outdoors network is owned by the power company, whereas the indoor network is a part of the premises in which the local consumer operates.

### SUMMARY OF THE INVENTION

The present invention provides a system and a method for interfacing home end-points with communications services borne by outdoors power lines. In accordance with the present invention a PLC (power line communications) interface is connected in parallel to a power line bearing the communications services, within the framework of a home electric power meter.

In accordance with the present invention, separation of communications signals and power, both carried by power carriers, take place by applying a combination of block band and a low pass filter.

By another aspect of the invention, a power meter receives communications signals from a communications service and sends communications signals to consumers through the PLC interface.

By another aspect of the invention, the PLC interface is a gateway that compatibly connects between the home communications network and the PLC service.

By yet another aspect of the invention, an electric power meter of a home consumer is connected to the PLC interface for delivering data to it and obtaining data from it.

### BRIEF DESCRIPTION OF THE DRAWINGS

FIG. 1 is schematic diagram illustrating the partitioning of deliverables borne by a power carrier in accordance with the present invention;

FIG. 2 is a block diagram illustrating schematically the bidirectional characteristics of the PLC interface of the invention;

FIG. 3 is a block diagram illustrating the sources of the information flowing through the PLC interface of the present invention;

FIG. 4 is a flow chart describing the series of steps carried out in order to extract the communications service information provided by the power line;

FIG. 5 is a block diagram illustrating the functional relations between the main components of an enhanced electric power meter of the invention;

FIG. 6 is a block diagram illustrating the functional relations between the main components of a PLC interface of the invention.

### A DESCRIPTION OF THE PRESENT INVENTION

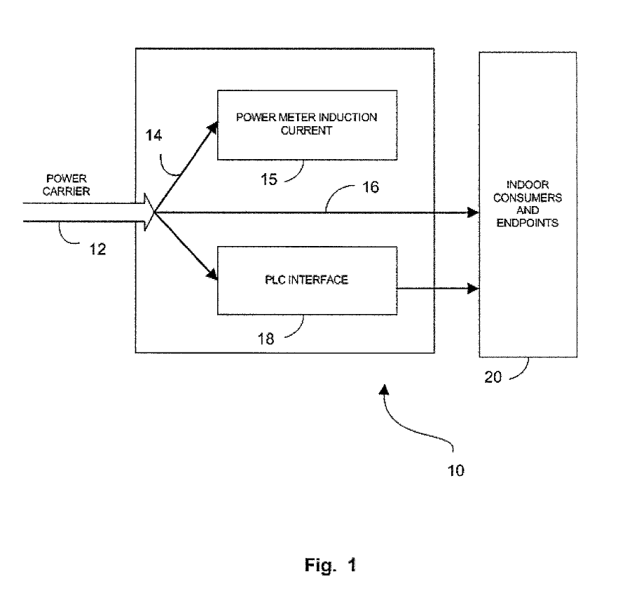

According to a preferred embodiment of the present invention, an electric power meter for monitoring power consumption by a home consumer, is modified to function also as a gateway for compatibly connecting the telecommunications services borne by the power line with an indoor communications network, typically a home consumer LAN. Reference is now made to FIG. 1, which describes the partitioning of deliverables borne by the power carrier in accordance with the present invention. Generally designated 10, the enhanced electric power meter, in accordance with a preferred embodiment of the present invention, lets off a portion 14 of the incoming current into the power meter to be consumed by the circuitry and induction current 15 thereof. The main portion of the current, designated 16, is directed to home consumers and end-points 20 for supplying current and power to them. PLC signals flow downstream from power carrier 12 through PLC interface 18, to indoor consumers and end-points 20. As will be explained later on, the interface 18 engages also in transmission of outdoors—bound communication signals, whose origin is in any one of the home end-points.

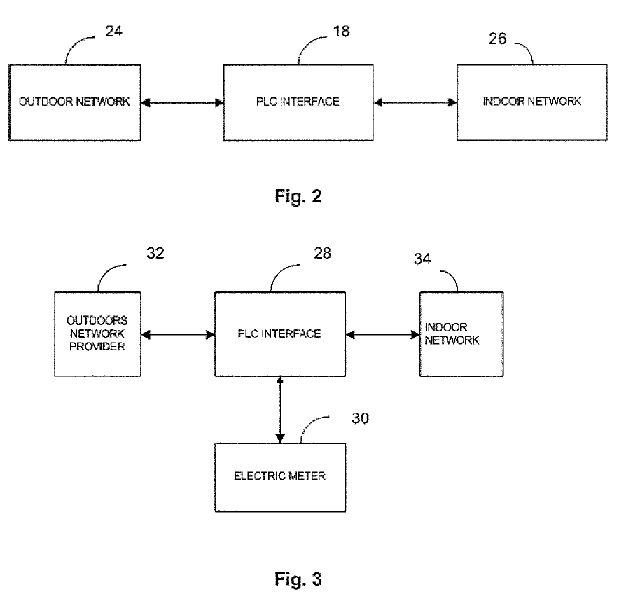

In FIG. 2, to which reference is now made, the bidirectional duty characteristics of PLC interface 18 is illustrated. In accordance with the present invention, the outdoors network 24, physically borne by the electricity carrier, transmits communications signals and receives communications signals from the PLC interface 18. On the other hand, the PLC interface 18 receives communications signals from the indoor network 26. Indoor network systems may be any useful type of network, such as token ring or Ethernet type LANs (local area networks) implemented on any type of infrastructure as elaborated below. In accordance with a preferred embodiment of the present invention, the PLC interface serves also as an information provider for both outdoors and indoor networks as regards the electricity consumption. To describe this aspect of the invention, reference is now made to FIG. 3. PLC interface 28 collects quantitative information regarding the flow of communications signals through it, and it collects from electric meter 30 information regarding the electric power. The PLC interface 28 sends reports of this information to the outdoors network provider 32 and to the indoor network 34. Furthermore, through the PLC interface 28, signals can be sent to the electric meter 30 for updated quantification parameters of the electric power, such as diurnal distribution and pricing related aspects.

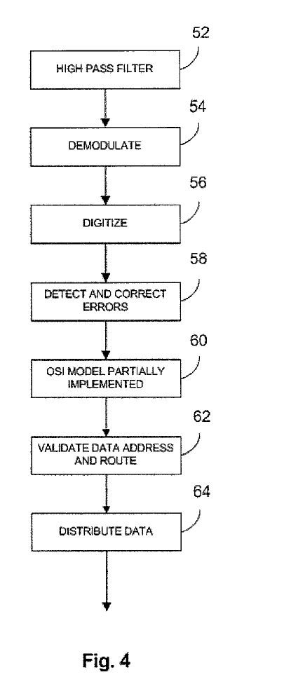

Reference is now made to FIG. 4, which illustrates the sequence of steps carried out in order to extract the communications signals borne by the power line in accordance with the present invention, within the framework of the PLC interface. In a preferred embodiment of the invention, the networking properties of the PLC comply with the standards related to the OSI (open system interconnection) model. This model, endorsed by the ISO (international standards organization) ensures interoperability of the system of the invention with commercial systems and appliances of the communications market. In step 52 the incoming downstream communications signals carried by the power carrier are high pass filtered. In step 54, communications signal is demodulated, extracting the communications signals from the communications signal. In step 56 the signal is digitized producing a digital communications signals stream. In step 58, error detection, correction, digital filtering and communications signals manipulation is carried out. In step 60 OSI protocols are implemented if required. In step 62 the communications signals address is verified, and if validity is confirmed, it is routed either to the electric meter or to the indoor network. In step 64 the communications signals is distributed to either the indoor communications network or to the electric meter.

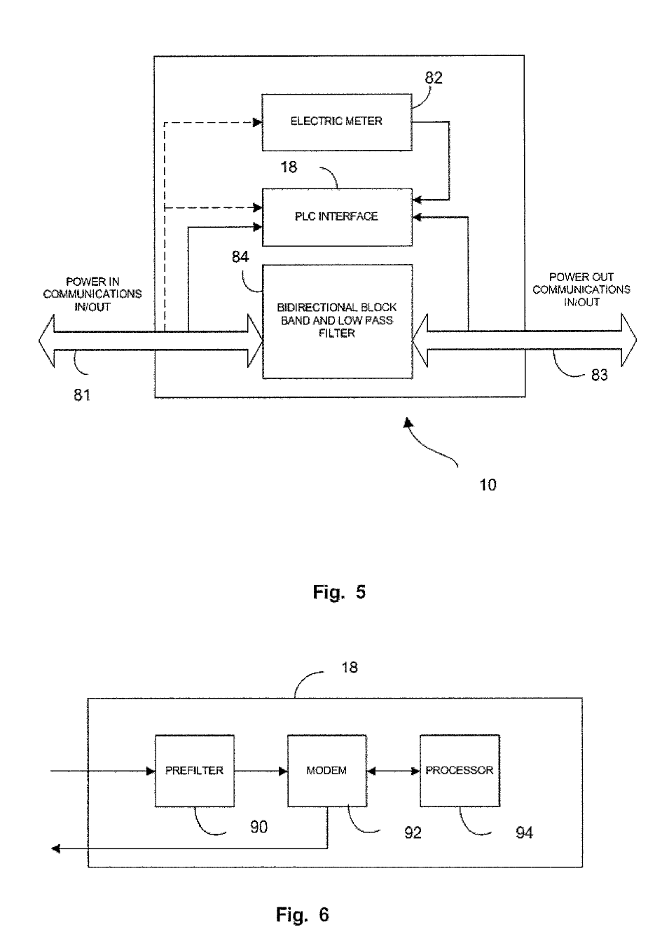

If the indoor communication network is a PLC (power line communications) network or another type of analog network, the communications signal is not digitized, for obtaining an analog signal containing the communications signals for distribution into the indoor network. In the upstream direction, data coming from the indoor network, is processed generally in the reverse direction, subsequently to transmit communications signals compatible with the operational requirements of the power line communications network. In the upstream direction, the PLC interface looks after the upstream communications traffic. Accordingly, the outgoing communication stream coming from the indoor network is passed on to the external power line carrier by way of the PLC interface. A general view of the functional aspect of the enhanced electric power meter 10 in accordance with a preferred embodiment of the invention, is shown in FIG. 5 to which reference is now made. The PLC interface 18 accepts and transmits communications signals such as containing bits of data signals, as shown by solid arrows, to and from the in -coming outdoor power line 81, to and from the electric meter 82, and to and from the indoor power lines designated by arrow 83, or from any indoor LAN. The dashed arrows designate the power feed for the PLC interface. The electric meter 82 derives power also from the power carrier as shown by a dashed line. The combined power and communications signals carriers are represented by arrows 81 and 83. As indicated, the power in line connects to bi directional block band and low pass filter 84 which connects at the other side to the indoor power (and communications signals) network. Upstream communications signals come through the indoor power carrier from the indoor network (not shown). The communications signals are rejected by the block band and low pass filter and are accepted by the PLC interface 18. From the PLC interface the upstream communications signals pass to the outdoors network (not shown).

In FIG. 6 architecture of a preferred embodiment of a PLC interface 18 according to the invention is schematically illustrated. A pre-filter 90 rejects unwanted energy, typically having low frequency. The filtered signals are demodulated and transformed to digital structure by modem 92, communications signals including control signals and addresses, are extracted in real time. In addition, part of the MAC (media access control) functions are performed by the PLC. In processor 94 the signals are further digitally filtered, decoded, analyzed, repacked and constructed in compliance with the protocols typically associated with the OSI model. The processor sends the data to the electric meter or to the indoor modem for routing and distributing into validated addresses.

The indoor network is typically PLC, Ethernet, Bluetooth, RF network, telephone line network, cable TV, coaxial cable network, infrared network or any other physical form of network. Each network functionally employs the appropriate network management standards.

Generally described, the PLC interface of the invention is integral with the enhanced electric power meter of the invention, but structurally, such a combination is not mandatory, and the PLC interface may be disposed outside of the power meter. It may occupy a different casing, but it may advantageously use electrical connections serving the conventional electric power meters.

1. An interface for partitioning and distributing deliverables borne by an outdoors power carrier to an indoor communications network, and wherein said interface connects between said indoor network and said outdoor power carrier bi-directionally, comprising:
a PLC (power lines communications) interface, connected in parallel to said power carrier for downloading communication signals from said power carrier, and for loading upstream communications signals;
a connection between said PLC interface and said indoor communications network;
a block band—low pass filter for directing upstream and downstream communications signals into said PLC interface, and
a pre-filter for preconditioning said communications signals.

2. An interface for receiving and sending communications signals downstream from outdoors power carrier to an indoor LAN (local area network) and to an electric meter, and for sending upstream communications signals from said indoor LAN and said electric meter to said outdoors power carrier.

3. An interface for receiving and sending communications signals downstream from outdoors power carrier to an indoor LAN (local area network), and for sending upstream communications signals from said indoor LAN to said outdoors power carrier as in claim 1, and wherein said communication signals are digital, and said PLC interface comprises at least one analog to digital converter, and at least one digital processor.

4. A method for bi-directionally interfacing between PLC (power line communications) service and home communications network, comprising:
separating between current and communications signals flow by employing a PLC interface connected in parallel to the power carrier;
demodulating and modulating incoming and outgoing communications signals respectively;
compatibly connecting between said PLC service and said home communications network, and
connecting end—points of said home communications network to said PLC communications service.

5. A method for bi-directionally interfacing between a PLC (power line communications) service and a home communications network as in claim 4, and wherein said separating between said power and said communications signals is implemented by a employing a bi-directional block band and a low pass filter.

6. A method for bi-directionally interfacing between a PLC (power line communications) service and a home communications network as in claim 4, and wherein said home communications network is borne physically by the home electrical power network.
